(19) United States
(12) Patent Application Publication
(10) Pub. No.: US 2007/0083073 A1
(43) Pub. Date: Apr. 12, 2007

(54) Catalyst and method for converting low molecular weight paraffinic hydrocarbons into alkenes and organic compounds with carbon numbers of 2 or more

(76) Inventors: Ebrahim Bagherzadeh, Sugarland, TX (US); Abbas Hassan, Sugarland, TX (US); Aziz Hassan, Sugarland, TX (US); Rayford G. Anthony, College Station, TX (US); Xianchun Wu, College Station, TX (US)

Correspondence Address: THE LAW OFFICES OF THOMAS L. ADAMS, 120 EAGLE ROCK AVENUE, P.O. BOX 340, EAST HANOVER, NJ, 07936, US

(21) Appl. No.: 11/517,839

(22) Filed: Sep. 5, 2006

Related U.S. Application Data
(60) Provisional application No. 60/713,990, filed on Sep. 2, 2005.

(51) Int. Cl. B01J 23/00

(52) U.S. Cl. 585/943; 502/302; 502/349; 502/340; 502/240; 502/263

(57) ABSTRACT

A catalyst and process for formation of hydrocarbons having carbon numbers of two or greater, the result of both oxidative coupling of methane (“OCM”), and other reforming reactions of OCM end products. An OCM catalyst has a structure represented by formula ABTiO₃, wherein A is samarium or tin, B is barium; the reforming catalysts a composition represented by formula XYZ, wherein X is a metal from Group IA, Group IIA or Group VIIIA, or not present, Y a metal from Group VA, Group VIA, Group VIIA or Group VIIIA, Z chosen from oxygen, silica, silicalite and alumina. The inventive catalyst comprises an OCM catalyst and a reforming catalyst blended together; when used in a reactor effects an increased yield of hydrocarbons having a carbon number greater than 2 (in excess of 27%-30%, first pass rate of methane conversion about 50%) than occurs under OCM conditions alone.

### CROSS-REFERENCE TO RELATED APPLICATIONS

This application claims the benefit of United States Provisional Application for Patent, Ser. No. 60/713,990, filed 2 Sep. 2005, the contents of which are hereby incorporated by reference herein in their entirety.

### FIELD OF THE INVENTION

The present invention relates to novel catalysts and processes for producing alkenes, carbon oxides, hydrogen and other organic compounds with carbon numbers of 2 or more from alkanes (also referred to herein as paraffinic alkanes) such as methane (CH₄) that are found as the major component in most natural gas streams. Once methane is converted to higher carbon number alkenes, such as ethylene, there are existing commercial technologies to further react the products of the present invention into liquid hydrocarbons, plastics and other valuable commodities. More particularly, the invention relates to a combination of oxidative and reducing/reforming catalyst components used in combination to control reaction temperatures in the catalytic reaction zone. The invention includes methods for the manufacture of the catalyst and describes process conditions for its use in converting alkanes into organic compounds with carbon numbers of 2 or more, carbon oxides, water and hydrogen, in a process referred to herein as the oxidative reforming of hydrocarbons.

### BACKGROUND OF THE INVENTION

Natural gas is predicted to outlast oil reserves by a significant margin and large quantities of methane, the main component of natural gas, are available in many areas of the world. Natural gas often contains about 80-100 mole percent methane, the balance being primarily heavier alkanes such as ethane. Alkanes of increasing carbon number are normally present in decreasing amounts in crude natural gas streams. Carbon dioxide, nitrogen, and other gases may also be present. Most natural gas is situated in areas that are geographically remote from population and industrial centers making it difficult to utilize these gas resources. The costs and hazards associated with the compression, transportation, and storage of natural gas make its' use economically unattractive. Also, in some regions where natural gas is found combined with liquid hydrocarbons, the natural gas is often flared to recover the liquids. This wasted resource also contributes to global carbon dioxide emissions and to undesirable global warming.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water (also called steam reforming) to produce carbon monoxide and hydrogen (i.e., synthesis gas or “syngas”). The reaction is shown in equation 1:
CH₄+H₂O=>CO+3H₂ (ΔH°₂₉₈=206.1 kJ/mol), methane-steam reforming. Equation 1:

In a second step, the syngas is converted to hydrocarbons, for example, Sasol Ltd. of South Africa utilizes the Fischer-Tropsch process to provide fuels that boil in the middle distillate range. Middle distillates are defined as organic compounds that are produced between kerosene and lubricating oil fractions in the refining processes. These include light fuel oils and diesel fuel as well as hydrocarbon waxes.

Current industrial use of methane as a chemical feedstock is also a two stage process. In the first process methane is converted to carbon monoxide and hydrogen (syngas) by either steam reforming (see Equation 1) or by dry reforming. In the dry reforming process, carbon dioxide and methane are subjected to high temperature (generally between about 700 degrees C. to about 800 degrees C.) in the presence of a catalyst. This in turn forms hydrogen and carbon monoxide (see Equation 5). Steam reforming currently is the major process used commercially for the conversion of methane to synthesis gas.

During syngas synthesis, other reactions, such as a water gas shift reaction, occur simultaneously with reactions shown in Equation 1. One such water gas reaction is shown in Equation 2 and is frequently in a dynamic equilibrium state.
CO+H₂O [symbol] CO₂+H₂ Equation 2:

Although steam reforming has been practiced for over five decades, efforts to improve the energy efficiency and reduce the capital investment required for this technology continue. Syngas, once produced, can then be converted to other compounds useful in the chemical industries. The two step process, syngas formation followed by reforming reactions, such as methanol synthesis, requires two reactor stages and is inherently inefficient due to heat and material losses as well as the need for additional capital equipment for processing and separating the resulting gas and liquid streams. Such a process is disclosed in U.S. Pat. No. 6,797,851 to Martens et al., where two reactors are utilized to produce olefins with each reactor having a different catalyst.

A third stage has been practiced also by converting the methanol produced to hydrocarbons composed of alkenes, alkanes, naphthas and aromatic compounds. The product distribution that is produced depends on the catalyst and the process conditions used for conversion of the methanol. Other more complex processes to convert natural gas to liquids have been described involving synthesis, transportation of the end product to another site followed by further processing (see U.S. Pat. No. 6,632,971 to Brown et al. which describes a process for converting natural gas to higher value products using a methanol refinery remote from the natural gas source).

The catalytic partial oxidation of hydrocarbons, e.g., natural gas or methane to syngas is known in the art. While currently limited as an industrial process, partial oxidation has recently attracted much attention due to its' significant inherent advantages, such as the significant heat that is released during the process, in contrast to steam reforming processes that consume large amounts of energy.

In catalytic partial oxidation, natural gas is mixed with air, oxygen-enriched air, or oxygen, and introduced to a catalyst at elevated temperatures and pressures. The partial oxidation of methane yields a syngas mixture with a H₂:CO ratio of 2:1, as shown in Equation 3.
CH₄+1/2O₂=>CO+2H₂ Equation 3:

The partial oxidation reaction is exothermic, while the steam reforming reaction is strongly endothermic. The highly exothermic reactions of partial oxidation have made it inherently difficult to control the reaction temperature in the catalyst bed. This is particularly true when scaling up the reaction from a micro reactor to a larger scale commercial reactor unit due to the additional heat generated in large reactors and the limited heat transfer available in a larger reactor. If heat is not removed or controlled in such a way that temperature control can be maintained, partial oxidation can transition to full oxidation with the major quantities of end products being relatively low value carbon dioxide and water. Furthermore, oxidation reactions are typically much faster than reforming reactions. The selectivity of catalytic partial oxidation to various end products are controlled by several factors, but one of the most important of these factors is the choice of catalyst composition. There is much prior art focusing on the partial oxidation of methane to syngas that then requires conversion to more valuable higher carbon number organic compounds in a second reaction stage. Many of the catalysts used in prior art for the partial oxidation of methane have included precious metals and/or rare earth compounds. The large volumes of expensive catalysts needed by prior art for catalytic partial oxidation processes and the need for a separate reforming operation have placed these processes generally outside the limits of economic justification.

For successful operation at commercial scale, the catalytic partial oxidation process must be able to achieve a high conversion of the methane feedstock at high gas hourly space velocities (GHSV), and selectivity of the process to the desired products. Such high conversion and selectivity must be achieved without detrimental effects to the catalyst, such as the formation of carbon deposits (“coke”) on the catalyst, which severely reduces catalyst performance. An approach to prevent partial oxidation reactions of methane from creating primarily carbon dioxide and water is to limit the availability of oxygen in the reaction zone. This often, however, results in coke formation on the catalyst. Accordingly, substantial effort has been devoted in the art to develop catalysts allowing commercial performance without coke formation.

A number of processes have been described in the art for the production of either syngas and/or organic compounds with carbon numbers of 2 or more (also denoted as C₂+ compounds) from methane via catalyzed partial oxidation reactions or the so called shift gas process followed by recombination of the syngas to produce organic compounds with carbon numbers of 2 or more.

As used herein, the term “C₂+compounds” refers to ethylene, ethane, propylene, butane, butene, heptane, hexane, heptene, octene and all other linear and cyclical hydrocarbons where two or more carbons are present. For the purpose of chemical analysis in the examples contained herein, organic compounds that remain in gaseous state were analyzed by means of gas chromatography and higher carbon number materials were collected as condensate liquids. Generally gaseous materials have carbon numbers less that about 8.

The noble metals have been used as catalysts for the partial oxidation of methane, but they are scarce and expensive. Less expensive catalysts such as nickel-based catalysts have the disadvantage of promoting coke formation on the catalyst during the reaction, which results in loss of catalytic activity. Metal carbides and nitrides have also been shown to exhibit catalytic properties similar to the precious metals. A. P. E. York et al., (Stud. Surf. Sci. Catal. (1997), 110 (3rd World Congress on Oxidation Catalysis, 1997), 711-720.) and Claridge et al. (J. Catalysis 180:85-100 (1998)) disclose the use of molybdenum and tungsten carbides as catalysts for the partial oxidation of methane to syngas but suffered from rapid catalyst deactivation.

U.S. Pat. No. 4,522,708 (Leclercq et al.) describes a process for reforming petroleum products by the catalysis of dehydrocyclization, isomerization, hydrogenolysis and dehydrogenation reactions, the improvement wherein the catalysts employed comprise a metal carbide.

U.S. Pat. No. 5,336,825 (Choudhary et al.) describes an integrated two step process for conversion of methane to liquid hydrocarbons of gasoline range.

U.S. Pat. No. 6,090,992 (Wu et al.) describes a carburized transition metal-alumina compound employed as a catalyst in the isomerization of a hydrocarbon feedstock comprising saturated hydrocarbons.

U.S. Pat. No. 6,207,609 (Gao et al.) describes a metastable molybdenum carbide catalyst for use as a catalyst for methane dry reforming reaction.

U.S. Pat. No. 6,461,539 to Gaffney describes metal carbide catalysts and a process for producing synthesis gas using a mixed metal carbide catalyst.

U.S. Pat. No. 6,488,907 (Barnes et al.) describes a method of converting a reactant gas mixture comprising hydrocarbon compounds with carbon numbers from 1 to 5 and oxygen into a product gas mixture comprising H₂ and CO using a catalyst comprising a catalytically active component selected from the group consisting of rhodium, platinum, ruthenium, iridium, rhenium, and combinations thereof, supported on a catalyst support chosen from the group consisting of oxide-dispersion-strengthened alloys comprising aluminum, chromium, and yttrium oxide, at least one metal selected from the group consisting of iron, nickel, and cobalt, and, optionally, titanium, and non-oxide-dispersion-strengthened alloys comprising chromium, aluminum, titanium, an element selected from the group consisting of yttrium, lanthanum and scandium, and at least one metal selected from the group consisting of iron, nickel and cobalt, the catalyst having a metal oxide layer disposed between said catalytically active component and the support.

U.S. Pat. No. 6,518,476 (Culp et al.) describes methods for manufacturing olefins such as ethylene and propylene from lower alkanes, that is, methane, ethane and/or propane, by oxidative dehydrogenation at elevated pressure.

U.S. Pat. No. 6,555,721 (Griffiths et al.) describes a process for producing a mono-olefin from a feedstock containing a paraffinic hydrocarbon comprising feeding a gaseous paraffinic hydrocarbon-containing feedstock and a molecular oxygen-containing gas to an autothermal cracker wherein they are reacted in the presence of a catalyst.

U.S. Pat. No. 6,596,912 (Lunsford et al.) discloses processes and systems for the conversion of methane in high yields to C₄+hydrocarbons. The principal steps of the recycle process include reacting methane and O₂ in an oxidative coupling reactor over a Mn/Na₂ WO₄/SiO₂ catalyst at 800 degrees C. to convert the methane to ethylene, and oligomerizing the ethylene product by reacting it with an H-ZSM-5 zeolite catalyst at 275 degrees C. in a catalytic reactor for subsequent conversion of the ethylene to higher hydrocarbons.

U.S. Pat. No. 6,602,920 (Hall et al.) discloses a process for converting natural gas to a liquid by converting a fraction of the gas stream to reactive hydrocarbons, primarily ethylene or acetylene, and reacting methane and the reactive hydrocarbons in the presence of an acidic catalyst to produce a liquid, predominantly naphtha or gasoline.

U.S. Pat. No. 6,623,720 (Thompson et al.) discloses transition metal carbides, nitrides and borides, and their oxygen containing analogs useful as water gas shift catalysts

U.S. Pat. No. 6,852,303 (Seegopaul et al.) discloses a molybdenum carbide compound for use as a catalyst for the methane dry reforming reaction and the water gas shift reaction.

U.S. Pat. No. 6,887,455 (Carpenter et al.) describes a reactor that utilizes a catalyst comprising rhodium dispersed on a refractory oxide support material which comprises as cations cerium and zirconium, wherein the weight ratio of cerium to zirconium in the support material is from 50:50 to 99.5:0.5. The catalyst is used in the self-sustaining combination of exothermic partial oxidation and endothermic steam-reforming to produce a gas-stream containing mainly hydrogen, carbon dioxide and nitrogen.

U.S. Pat. No. 6,930,068 (Kaneko et al.) describes a methanol reforming catalyst for generating hydrogen by reforming methanol in the atmosphere containing oxygen and steam contains a metal oxide support and Pd—Zr alloy. The reforming catalyst accelerate a steam reforming reaction of the methanol as an endothermic reaction and a partial oxidation reaction of the methanol as an exothermic reaction while suppressing generation of CO gas.

United States Patent App. Pub. No. 2004/0267079 A1 (Mamedov et al.) discloses the use of oxidation catalysts used either by themselves or in series with other oxidation catalysts to form benzene, ethylene and syngas.

The prior art does not contemplate the present invention that combines oxidative coupling with a reforming catalyst compounds to form a novel catalyst composition in order to obtain high conversions of methane and high selectivity to C2+ organic compounds. Previous inventions utilizing oxidative reactions have also been limited in the size of reactors and amount of catalyst used due to the need to rapidly extract heat to avoid the formation of undesirable combustion products (primarily CO₂ and H₂O). Previous inventions have also shown poor catalyst life and/or low conversions and yields of desired reaction products. Previous inventions have relied mainly on partial oxidation of methane that results in high levels of undesirable carbon oxides and water or dehydrogenation type mechanisms that result in carbon formation and coking of the catalyst. Yet there is a continuing need for better processes and catalysts for the conversion of methane directly to higher carbon number organic compounds that can be directly used in chemical synthesis without going through the costly and inefficient step of first converting methane to syngas. The process and catalyst must exhibit long catalytic activity at high space velocities and be scalable to a size that can be utilized in a commercial process.

### BRIEF SUMMARY OF THE INVENTION

Embodiments of the present invention relate to the oxidative reforming of hydrocarbons, which as has been defined herein, refers to the formation of hydrocarbons having carbon numbers of two (2) or greater as a result of both the oxidative coupling of methane (“OCM”), and other reforming reactions of the OCM end products.

The present invention provides a process for supplying a feed gas mixture comprised mainly of methane and oxygen and optionally recycled CO₂ that is fed over a novel catalyst under conditions that result in near isothermal conditions. The feed gas is converted to a mixture of alkenes, carbon monoxide, hydrogen and other higher carbon number organic compounds that can be used in chemical synthesis reactions, or as a liquid fuel. We have identified a catalyst species which is extremely effective for oxidatively reforming (i.e., by the combination of partial oxidation and steam reforming) hydrocarbons. The present invention overcomes the many shortcomings of previous processes to convert natural gas into more usable products. Also provided are processes for making the new catalysts and processes for producing products such as ethylene, ethane, carbon monoxide and hydrogen using these catalysts. Excellent levels of conversion of methane and oxygen reactants and selectivity for producing organic compounds with carbon numbers of 2 or more are achievable by the new catalysts and process. Although not wishing to be bound by a particular theory, the inventors believe that the primary reactions catalyzed by the preferred catalysts described herein is the partial oxidation reactions as well as reforming reactions shown in Equations 1-13 in the Detailed Description section.

The OCM reactions utilize a catalyst that has a perovskite structure, and is represented by the formula ABTiO₃, wherein A is either samarium (Sm) or tin (Sn) and B is barium (Ba), while the reforming catalysts described herein have a composition that is represented by the formula XYZ, wherein X is a metal selected from Group IA, Group IIA or Group VIIIA of the Periodic Table of the Elements, or X may not be present in the composition, Y is a metal selected from Group VA, Group VIA, Group VIIA or Group VIIIA of the Periodic Table of the Elements, and Z is chosen from the group consisting of oxygen, silica, silicalite and alumina.

The OCM and reforming catalysts are individually synthesized, and blended together to form the oxidative reforming catalyst. When the oxidative reforming catalyst is used in an oxidative reforming reactor, there is an increased yield of hydrocarbons having a carbon number greater than 2 than occurs under OCM conditions alone. The addition of a halogen such as chloride to the feed gas results in an increased yield of hydrocarbons having a carbon number greater than 2, as does the recycling of the carbon dioxide gas that is produced during the oxidative reforming process.

An advantage of the oxidative reforming process is a reduction in the amount of undesirable coking. Use of the oxidative reforming catalyst promotes oxidative coupling of methane and other reactions with first pass rates of methane conversion of approximately 50% and yield of organic compounds with carbon numbers greater than 2 that exceed 27%, and in some instances, exceed 30%.

### BRIEF DESCRIPTION OF THE SEVERAL VIEWS OF THE DRAWING

FIG. 1 is a schematic illustration of the reactor used in embodiments of the present invention.

FIG. 2 is a schematic representation of the temperature profile used for calcining embodiments of catalyst.

FIG. 3 summarizes the effects of methane conversion to organic compounds as a function of time. TOS refers to Time on Stream.

FIG. 4 summarizes the effects of reactor temperature on methane conversion to organic compounds. Trx refers to the maximum temperature measured in the catalyst bed.

FIG. 5 illustrates the effects of CCl₄ addition on methane conversion to organic compounds as a function of time. TOS refers to Time on Stream.

FIG. 6 illustrates the effects of added oxygen on methane conversion to organic compounds as a function of time. TOS refers to Time on Stream.

FIG. 7 is an X-Ray Diffraction analysis of one catalyst embodiment used to produce the products of methane conversion to organic compounds.

FIG. 8 illustrates the effects of a single EPC catalyst in promoting endothermic reactions.

### DETAILED DESCRIPTION OF THE INVENTION

The present invention provides a process for supplying a feed gas mixture comprised mainly of methane and oxygen and optionally recycled CO₂ that is fed over a novel catalyst under conditions that result in near isothermal conditions. The feed gas is converted to a mixture of alkenes, carbon monoxide, hydrogen and other higher carbon number organic compounds that can be used in chemical synthesis reactions or as a liquid fuel. We have identified a catalyst species which is extremely effective for oxidatively reforming (i.e., by the combination of partial oxidation and steam reforming) hydrocarbons. The present invention overcomes the many shortcomings of previous processes to convert natural gas into more usable products. Also provided are processes for making embodiments of the new catalysts and processes for producing products such as ethylene, ethane, carbon monoxide and hydrogen using these catalysts. Excellent levels of conversion of methane and oxygen reactants and selectivity for producing organic compounds with carbon numbers of 2 or more are achievable by the new catalysts and process. Although not wishing to be bound by a particular theory, the inventors believe that the primary reactions catalyzed by the preferred catalysts described herein is the partial oxidation reactions as well as reforming reactions shown in Equations 1-13.

Other reactions such as reforming with carbon dioxide and water gas shift reactions have also been shown to be present. Carbon dioxide may be regenerating the catalyst with the corresponding production of carbon monoxide and an oxidized catalyst site.
CH₄+2O₂=>CO₂+2H₂O Equation 4:
CH₄+CO₂=>2CO+2H₂ Equation 5:
2CH₄+O₂=>2CO+4H₂ Equation 6:
CH₄+O₂=>CO+H₂+H₂O Equation 7:
2CH₄+1O₂=>C₂H₄+2H₂O Equation 8:
2 CH₄+1/2O₂=>C₂H₄+H₂O+H₂ Equation 9:
CO₂+4H₂=>CH₄+2H₂O (probability of this reaction is extremely low) Equation 10:
CO₂+H₂=>CO+H₂O Equation 11:
2CO₂+2CH=>C₂H₄+2CO+2H₂O Equation 12:
3CO₂+4CH₄=>C₄H₄+5H₂O+CO Equation 13:

The reactions in Equation 5 and 11 are both favorable (from a kinetics analysis), and are also endothermic.

The oxidation of methane to carbon dioxide and water (Equation 1) is very favorable and highly exothermic.

The oxidative coupling catalyst may also react by cleaving hydrogen from methane to form free radicals that may then react directly with other active compounds. An alternative route that might be possible is formation of carbene radicals, because of high surface reaction temperatures. These reactions are illustrated as follows:
2CH₄+O₂→2CH₂:+2H₂O Equation 14:
2CH₂:→C₂H₄ Equation 15:

Embodiments of the present invention utilize a catalyst combination that utilizes oxidative coupling, water gas shift and reforming mechanisms as well as intermediates in the reaction to form C₂+compounds. Prior to the present invention, oxidative coupling of, methane had limitations for conversion of methane to higher carbon number organic compounds because as reactor size was increased, control of the highly exothermic reaction was difficult resulting in poor temperature control. Too high a temperature results in conversion to mainly carbon dioxide and water. Too low of a temperature yields low conversion of methane. Prior art in this area utilizes micro reactors with catalyst content of about 1 gram. The present invention has been utilized on reactors up to 1½ in. in diameter and with catalyst charge of up to 175 grams. The present invention utilizes a novel catalyst that results in both endothermic and exothermic reactions thus allowing for high conversions of methane to higher carbon materials in larger scale reactors with good temperature control. Other chemical reactions may also occur, but to a lesser extent, catalyzed by the same catalyst composition. Examples of how these higher carbon number compounds might form from the reactant products are shown in Equations 1-15, as well as in Equations 16-17.
2CO+4H₂=>C₂H₄+2H₂O Equation 16:
2CO+5H₂=>C₂H₆+2H₂O Equation 17:
2CH₄+1/2O2=>H₂O+C₂H₆=>C₂H₄+H₂O+H₂ (Partial oxidation of methane followed by dehydrogenation of ethane) Equation 18:

What reactions in fact do occur will be determined by the thermodynamic and kinetic properties. Only the kinetic properties of the system are determined by the catalyst. The novel catalyst of the present invention may result in many different equilibrium constants present depending on the local thermodynamic condition. The present invention makes use of both catalyzing favorable endothermic reactions, such as CO₂+CH4=>2CO+2H₂ (Equation 5) as well as exothermic reactions such as O₂+2CH₄=>2CO+4H₂ (Equation 6) occurring in the catalyst bed to control reaction temperatures and reduce the production of unfavorable combustion products of CO₂ and H₂O. Once the intermediary reaction products (primarily methyl and carbene radicals) are formed, conditions are favorable for the production of organic compounds with carbon numbers of 2 or more. Selectivity can be controlled by minimizing the total combustion of these intermediate components to maximize selectivity to C₂+ organic compounds and minimize generation of heat. Energy generated by combustion of the methane is on the order of 199 kcal/mole of methane consumed whereas the energy generated for production of ethylene is of the order of 33 kcal/mole of methane consumed.

In the Examples, evidence of the occurrence of both reactions is revealed by the heat generated in the reaction (exothermic reactions) and the lower levels of H₂ produced to methane consumed indicate the reverse water gas shift reaction (an endothermic reaction).

Other feed gases may include other hydrocarbons such as ethane, propane, butane, hexane, heptane, normal-octane, iso-octane, naphthas, liquefied petroleum gas, and middle distillate hydrocarbons.

One advantage of the catalysts and processes of the present invention is that no appreciable coking occurs with use of the new catalyst compositions, and eventual catalyst deactivation is delayed or avoided. Addition of halogen such as chlorine or a chloride-containing compound further enhances catalyst life and selectivity to the C₂+ hydrocarbons. The optimal amount of the halogen, or chlorine or a chloride containing compound, such as carbon tetrachloride, ethylene dichloride or other chloride compounds (could be used, such as, for example only, methane chloride, ethane chloride, hydrochloric acid, stannous chloride ((SnCl₂)) is on the order of micro liters/gram-catalyst. The halogen is added to the mixture to give a final concentration ranging from about 0.001% volume/volume (“v/v”) to about 0.04% v/v. In other embodiments, the halogen is added to a final concentration ranging from about 0.008% v/v to about 0.02% v/v.

Although not wanting to be limited to a single mechanism, theoretically or otherwise, the chloride is believed to promote ionic formation in the catalyst. Another advantage of the novel catalysts of the present invention and processes is that the resulting product mixture favors the production of carbon monoxide and hydrogen; i.e., hydrogen is a product of the present process, and/or more hydrogen is combined with carbon in the final products, as hydrocarbons, than in other processes. This is in contrast to prior art processes where the hydrogen generated would tend to form water.

Another embodiment of the present invention recycles the carbon dioxide produced by the reaction back into the feed gas. In the examples provided herein, the use of recycled carbon dioxide is shown to be beneficial to the overall reaction. Although not wanting to be limited to a single mechanism or theory, the mechanism for this beneficial effect of carbon dioxide in the feed gas is most likely a combination of its reacting through mechanisms shown in Equations 2, 4, 5, 10, 11, 12 and 13 as well as acting as a diluent heat sink gas for the reaction. Example 11 of the present invention illustrates the effect of CO₂ with one catalyst embodiment of the present invention.

In accordance with certain embodiments of the present invention an oxidation coupling catalyst component is first prepared followed by the preparation of a second reducing and or water gas shift catalyst component. This second component will be referred to as an Endothermic reaction Promoting catalyst Component (EPC). The oxidation coupling component of the catalyst can also be referred to as an Oxidative Coupling of Methane (OCM) component. The two components, OCM and EPC, are combined and put through a heat history that result in a unique catalyst composition that is useful in converting methane to higher carbon number organic compounds. The resulting catalyst formed by the combination of OCM and EPC components is designated herein as OCM/EPC catalyst. For purposes of this specification, the combined process herein will be referred to as the oxidative reforming of hydrocarbons, and the OCM/EPC catalyst embodiments may also be referred to as oxidative reforming catalysts.

The OCM/EPC catalyst may be applied to a porous or gas permeable support. The catalyst and/or the support may be in the structural form of a gauze, monolith or foam, for example. The support may contain a material such as MgO, Al₂O₃, SiO₂, TiO₂, titanosilicate, activated carbon, carbon molecular sieves, crystalline and non-crystalline molecular sieves, ZrO₂, mullite (an alumina silicate with the formula 3Al₂O₃×2SiO₂), cordierite (a ceramic material of the formula 2MgO-2Al₂O₃-5SiO₂), ceramics and mixtures thereof. The mixed metal catalysts may also be mixed with, deposited or impregnated into such materials. The OCM/EPC catalyst may also be made by pulverizing the OCM and EPC components and then mechanically mixing the two in the appropriate amounts followed by pressing and subsequent pulverizing to the desired particle size. Although each component (OCM and EPC) of the OCM/EPC catalyst is an active catalyst by itself, it has unexpectedly been discovered that when the components are combined and subjected to a heat history, the combination of metals in the composition forms a unique crystalline structure that is effective in converting methane to ethylene and organic compounds having carbon numbers of 2 or greater. Embodiments of the catalyst composition have a crystalline structure characteristic of a perovskite composition.

Some embodiments of the process for making the OCM catalyst also include promoters in the composition. The promoters may be a metal or metal oxide of the rare earth, alkali, or alkaline earth elements, commonly referred to as transition elements, i.e., elements from Group IVA through IB, elements from Group IVB of the periodic table or combinations thereof. One or more promoter metals may be used in preparation of the OCM catalyst.

Certain embodiments of the process for making the OCM and EPC catalyst also include preparation of the catalyst in an inert atmosphere which could be achieved by a number of methods that are well known in the art of catalyst synthesis. One such method, for example, is using an atmosphere of nitrogen.

The processes for making the OCM catalysts employ a metal compound with the metal selected from Group IIA or Groups IIIA through VIIA as the first metal compound and the second metal compound is a compound of an element selected from Groups IA or IIA of the periodic table. In some embodiments the intermediate compound comprises about two to fifty weight (“wt”) % of the metal content of the mixed metal catalyst, while the alkali or alkaline earth compound comprises about two to fifty wt %. In other embodiments of the process the first metal compound is a titanium oxide, alkoxide or nitrate which comprises about two to seventy wt % of the metal content of the mixed metal catalyst, and each of the at least one second metal compound contains a different metal chosen from the group consisting of the alkali or alkaline earth compounds.

In some embodiments of the OCM component, the catalysts comprise a mixed metal composition containing a first metal which is titanium and comprises at least 5 to 20 wt % of the metal content of the mixed metal catalyst. The catalyst also contains at least one second metal compound different than the first metal, and which second metal is barium. The second metal comprises about 40 to 80 wt % of the metal content of the active components of the mixed metal catalyst.

In certain embodiments, the first metal in the OCM component is titanium and the second metal is barium. In some of these embodiments, Ba comprises about 64 wt % of the metal content of the mixed metal catalyst, and Sn or Sm comprises about 10 to 30 wt % of the metal content. In other embodiments, the first metal is Ti comprising about 10 to 20 wt % of the metal content of the mixed metal catalyst, and each of the second metal(s) is Sm or Sn.

Another aspect of the present invention is a process for forming a product gas mixture comprising hydrocarbons with carbon numbers of 2 or more by a combination of net partial oxidation, water gas shift, cracking and reforming reactions. In some embodiments the process comprises contacting a reactant gas mixture comprising the hydrocarbon and a source of oxygen with a catalytically effective amount of an OCM/EPC catalyst, as described above. The process includes maintaining the catalyst and the reactant gas mixture at conversion-promoting conditions of temperature, reactant gas composition and flow rate during this contacting. In some embodiments the OCM/EPC catalyst employed in the process is a supported catalyst. In some embodiments, the OCM/EPC catalyst used in the process includes a promoter.

The EPC component of the present invention can incorporate any of the known metals that promote reduction (reduction reactions involve a process where electrons are “gained” and the oxidation state of some atom decrease). Any number of reducing/reforming/water gas shift metals may be used in the present invention for the EPC component. A number of metals were evaluated as shown in Table 2. Molybdenum is one such metal that can act as a reducing catalyst and was shown to be effective in embodiments of the present invention.

The reactor may be any suitable reactor, such as a fixed bed reactor with axial or radial flow and with inter stage cooling or a fluidized bed reactor equipped with internal and external heat exchangers. In one embodiment, the reactor is a fixed bed reactor which is lined with an inert material such as alumina or fused quartz. Most preferably, the lining is quartz. A suitable catalyst is provided in the reactor to facilitate or catalyze conversion of methane to organic compounds with carbon numbers greater than 2. One embodiment utilizes a catalyst consisting of an OCM/EPC catalyst.

It has also unexpectedly been discovered that a titanium reactor tube can also be utilized with the present catalyst and process. It has been discovered that a titanium tube that is preheated in the presence of oxygen to about 900 degrees C. will form a protective oxide skin; the tube may then be used in the reactor and will not interfere with the preferred reactions. The use of a titanium reactor also facilitates operation at elevated pressures. Varying the pressure of the reaction zone of the present invention allows for adjustment of the type of alkenes and C2+ components produced. Use of stainless and other metals increases the production of undesirable carbon dioxide under the reaction conditions of the present invention.

The temperature of the reactor is maintained at a temperature of between about 650 degrees C. and about 950 degrees C. In other embodiments the temperature of the reactor is maintained between about 700 degrees C. and about 950 degrees C. Still in other embodiments the step of converting the methane to higher carbon number organic compounds takes place in a temperature range of about 750 degrees to 850 degrees C.

In some embodiments of the hydrocarbon conversion processes, the step of maintaining the catalyst and the reactant gas mixture at conversion promoting conditions of temperature and pressure during contacting includes maintaining a pressure of from about 100 kPa to about 250 kPa. In certain embodiments, the pressure is maintained at about 200 kPa.

Some embodiments of the processes for converting methane to organic compounds with carbon number of 2 or more comprise mixing natural gas, comprised primarily of methane as a feedstock and an oxygen-containing gas feedstock combined with carbon dioxide, preferably from a recycle stream to provide a reactant gas mixture feedstock having a composition of ethane, carbon monoxide, hydrogen, carbon dioxide and oxygen. Certain of these embodiments provide for a reactant gas mixture feed having a carbon:oxygen atom to mole ratio of about one to about five, and certain embodiments provide a reactant gas mixture feed having a carbon:oxygen ratio of about 1.5 to about 3.

In some embodiments of the hydrocarbon conversion processes the oxygen-containing gas further comprises steam, CO₂, or a combination thereof, and the process includes mixing a hydrocarbon feedstock and a gas comprising steam and/or CO₂ to provide the reactant gas mixture.

The feed gas hydrocarbon comprises at least about 50% methane by volume in some process embodiments of the invention, and in some embodiments the hydrocarbon contains at least about 80% methane. In certain embodiments the hydrocarbon feedstock and the oxygen-containing feedstock are both pre-heated before contacting the catalyst. In certain embodiments the reactant gas mixture is passed over the catalyst at a space velocity of about 500 to about 30,000 normal liters of gas per liter of catalyst per hour (NL/L/h), and in some of these embodiments the space velocity is about 2000 to 10,000 NL/L/h. Some embodiments of the hydrocarbon conversion processes provide for retaining the catalyst in a fixed bed reaction zone. These and other embodiments, features and advantages of the present invention will become apparent with reference to the following description.

It is also contemplated in the present invention to utilize separation and recycling of the un-reacted and combustion by-products of the present process in order to increase the overall yield of methane to organic compounds with carbon numbers of 2 or greater. Several recent studies have demonstrated that product yields approaching 70 to 80% may be achieved by employing a recycle reactor with continuous removal of ethylene (Y. Jiang et al., Science 264:1563, 1994; R. B. Hall et al., ACS Div. Petr. Chem. Prepr. 39(2):214, 1994; E. M. Cordi et al., Appl. Catal. A: Gen. 155:L1-L7, 1997; A. Mashocki, Appl. Catal. A: General 146:391, 1996). The ethylene may either be directly separated from the recycle stream or it may be converted to another product, which is subsequently separated.

Catalyst Preparation

Metal oxide catalysts useful for the catalytic net partial oxidation of methane (OCM), water gas shift and reforming reactions (EPC) are prepared by first combining compounds of titanium, barium and Sn or Sm. The Ti metal component of the catalysts comprises at least 16 wt %. The different second metal component can vary from 40 to 70 weight percent and is selected from the group consisting of alkaline earth metals. Metals selected from the group consisting of transition elements and from about 2 to 50 weight percent are preferred. Other metals were evaluated in the OCM component as shown in Table 1, however Sn, Ti and Ba were found to be most suitable.

The metal compounds chosen are oxides, although other compounds such as alkoxides and nitrites may be used. Then at least two metal compounds are then mixed by sol-sol method and calcined according to procedures described in United States Patent Application Pub. No. 2004/0220053, the contents of which are hereby incorporated by reference herein in their entirety. Catalysts containing Na, K, Ba, Sm, Sn, Mo and Ti, together, are especially preferred for obtaining a high conversion of methane and high selectivity for organic compounds with carbon numbers of 2 or more. The inventors have discovered that this process and catalyst provides an unexpected, synergistic effect when employed to convert natural gas into higher carbon number compounds in a short contact time reactor.

The following tables list the composition and preparation technique for the catalysts used in the Examples.

Table 1 lists the composition of the OCM components of the novel catalyst with techniques outlined in United States Patent App. Pub. No. 2004/0220053 A1 (Bagherzadeh et al., the contents of which are hereby incorporated by reference herein). In the referenced application the OCM catalyst was prepared using 187.5 grams of BaCO₃ with 11.1 grams of SnCl₂.2H₂O with 80.0 grams of TiO₂ and processed, calcined, and pressed (at 7 tons/sq in). In the table below, this is identical to Catalyst No 14.

Table 2 lists the composition for the EPC portion of the novel catalyst. For this process of making the novel catalyst there is physical mixing or impregnation that can be accomplished in various types of mixing devices familiar to those experienced in the art. For the purpose of these experiments the mixing was done in a mortar and pestle followed by pressing in an arbor press, and then broken into granules suitable for the size of the reactor being used. As will be described in the following examples, the particle sizes ranged from about one-tenth millimeter (0.1 mm) to about 5 millimeters (5 mm). In some experiments, particles having an average size ranging from about 0.15 mm to about 0,45 mm were used, and others used particles having an average size ranging from about 2 mm to about 4 mm.

TABLE 1
List of Oxidation Catalyst used in Examples

| Catalyst | | |
|---|---|---|
| Designation | Formulations | Method of Preparation |
| 1 | SmBaTiO3 (1:1:1 molar ratio) | Sol-Gel |
| 2 | SmBaTiO3 (1:1:1 molar ratio) | Sol-Gel-(prepared under |
| | | N2 atmosphere) |
| 3 | SmBaTiO3 (1:1:1 molar ratio) | Sol-Gel |
| 4 | SmBaTiO3 (1:1:1 molar ratio) | Sol-Gel-(prepared under |
| | | O2 atmosphere) |
| 5 | SmBaTiO3/FeMoO4 (70:30 | Physical Blend |
| | wt %) | |
| 6 | NaMo/SiO2 (1-1-1 molar ratio) | Impregnate |
| 7 | NaCr/silicaliteSiO2 (5% Na, | Impregnate |
| | 5% Cr, 90% SiO2) | |
| 8 | NaMo/(alpha Al2O3) Na 5%, | Impregnate |
| | 10% Mo, Balance 85% Al2O3 | |
| 9 | KV on SiO2, 5% K, 10% V, | Sol-Sol |
| | 85% SiO2 | |
| 10 | Pt—Re/SiO2 (3% Pt, 3% Re | Impregnate |
| | on gamma Al2O3, 94%) | |
| 11 | 10 wt % Mo/alpha alumina | Impregnate |
| | (90 wt %) | |
| 12 | Na Ru/SiO2, 5% Na, | Impregnate |
| | 10% Ru on SiO2 (85%) | |
| 13 | 10% Nb on alpha alumina (90%) | Impregnate |
| 14 | SnBaTiO3 (1:1:1 molar ratio) | Sol—Sol |

TABLE 2
List of Catalyst used in Examples made with 2 step process

| Catalyst | | Method of |
|---|---|---|
| Designation | Formulations | Preparation |
| 15 | NaMo/SiO2 (1-1-1 molar ratio) | Sol—Sol |
| 16 | NaCr/SiO2 (5% Na, 5% Cr, 90% SiO2) | Impregnate |
| 17 | 10% Mo on alpha Al2O3 (90%) | Impregnate |
| 18 | NaMo on alpha Al2O3; Na 5%, | Impregnate |
| | 10% Mo, 85% Al2O3 | |
| 19 | KV on SiO2, 5% K, 10% V, 85% SiO2 | Sol—Sol |
| 20 | Pt—Re/SiO2(3 wt % Pt, 3 wt % Re on | Impregnate |
| | gamma Al2O3 94% | |
| 21 | 10 wt % Mo on alpha alumina (90%) | Impregnate |
| 22 | Na Ru/SiO2, 5% Na, 10% Ru on SiO2 85% | Impregnate |
| 23 | 10% Nb on alpha alumina 90% | Impregnate |
| 24 | Vanadium (2.8 wt % V) on | Impregnate |
| | alpha-alumina (97.2 wt %) | |
| 25 | BaMoO4 | Sol—Sol |

%: refers to weight percent (wt %)

Although the technique for making the OCM or EPC component is listed as sol-sol or sol-gel; either preparation technique may be utilized. Optimization of the desired reactor outlet composition may influence which technique is used. Specific preparation conditions and equipment is given in the examples that follow.

Thus when reference is made to the combined catalyst components, such as Catalyst Component 4 with Catalyst Component 15, this means that Catalyst Component 4 was combined with Catalyst Component 15 as a dry blend and then pressed and ground. The combined catalyst components were then either calcined again in a furnace before use in the reactor or treated in the reactor by exposing to heat (up to 900 degrees C. for 3-4 hrs). In the following examples it is shown through X-ray diffraction (“XRD”) that there was some reformation of the crystalline structure of the individual catalyst components after they were exposed to a heat history encountered in the reactor.

### EXAMPLES

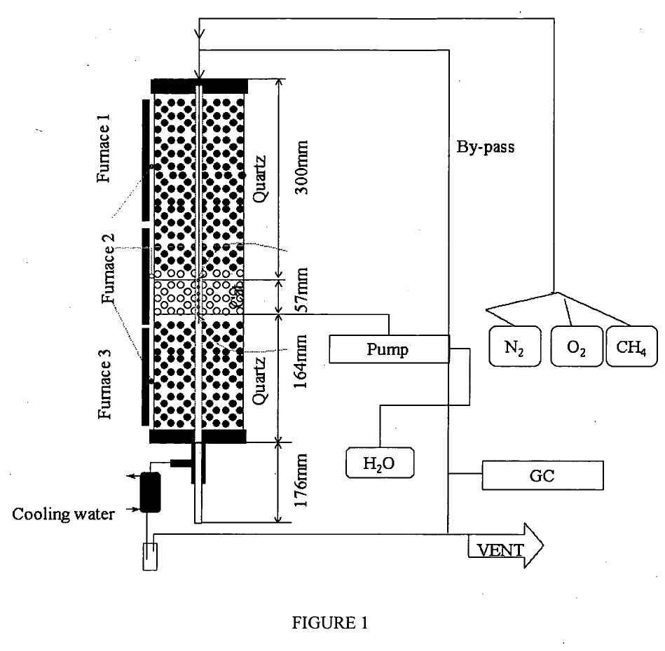

The mixed metal oxide catalysts in the following examples are placed in a tubular reactor with a thermowell covered with a quartz cover and a quartz liner (See FIG. 1). Also utilized was an unlined titanium reactor that was pre-treated to oxidize the internal surface area prior to use. Although FIG. 1 shows a reactor with only top feeding of input gases, some examples utilize multiple gas feed points along the length of the catalyst bed. The catalyst bed is configured as three layers i. quartz packing, ii. catalyst, iii. quartz packing. A feed stream comprising methane, carbon dioxide, nitrogen as an internal standard and an oxygen-containing gas is contacted with one of the above-described catalysts in a reaction zone maintained at a temperature sufficiently high to effectively produce an effluent stream comprising organic compounds with carbon numbers of 2 or more, un-reacted methane, carbon monoxide, carbon dioxide, nitrogen as the internal standard and hydrogen. The hydrocarbon feedstock may be any hydrocarbon having a low boiling point, such as methane, natural gas, associated gas (natural gas which is found in association with crude oil either dissolved in the oil or as a cap of free gas above the oil). The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane. Other higher carbon number feedstocks, such as middle distillates, can be heated to a gas and utilized with embodiments of the present invention; however, the resulting products may differ depending upon the nature of the feedstock. The methane gas used for the feedstock had a purity of 99.9%.

The hydrocarbon feedstock is in the gaseous phase when contacting the catalyst. The hydrocarbon feedstock is contacted with the catalyst as a mixture with an oxygen-containing gas, preferably pure oxygen. The oxygen-containing gas may also comprise steam, CO, nitrogen and/or CO₂ in addition to oxygen. Carbon tetrachloride (CCl₄) is injected at the rate of 0.2 microliter every two hours to maintain catalyst activity.

The catalyst is initially heated, and after ignition, endothermic and exothermic reactions occur in the catalyst bed, and the reaction conditions are maintained to promote continuation of this process. In the experimental reactor the rate of heat loss is greater than the heat generated by reaction. However, the reaction may be close to adiabatic with larger reactor designs and further balancing of the endothermic and exothermic reaction conditions. Residence time, amount of feed preheat and amount of nitrogen dilution, if used, also affect the reaction products. Preferably a catalyst residence time of no more than about 1000 milliseconds for the reactant gas mixture is maintained.

The process may be operated a various pressures, depending on the desired output composition. The pressures may be from about 0.5 atm to about 15 atm, preferably from about 0.0089 kPa to about 0.014 kPa (1 atm=0.0098692*kPa). The process is preferably operated at temperatures of from about 600 degrees C. to about 1000 degrees C, preferably from about 650 degrees C. to about 950 degrees C. The hydrocarbon feedstock carbon dioxide and the oxygen-containing gas are preferably pre-heated before contact with the catalyst.

The hydrocarbon feedstock and the oxygen-containing gas are passed over the catalyst at any of a variety of space velocities. Space velocities for the process, stated as gas hourly space velocity (GHSV) of from about 300 to 5,000 volumes reactant per volume of catalyst per hour is utilized, preferably from about 2000 to about 5,000. Units of gas flow were measured as normal liters of gas per liter of catalyst per hour (NL/Lh) and are from about 1000 to about 30,000 NL/Lh, preferably from about 2000 to about 10,000 NL/Lh The effluent stream of product gases emerges from the reactor.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The disclosures of all patents and publications cited herein are incorporated by reference in their entirety.

In the Examples which follow, several techniques were used to prepare the various catalysts, which were then used as described further below.

1. Sol-Gel Method for Preparation of the Catalyst Component.

The catalyst components in Table 1and 2 that were prepared using the sol-gel technique were prepared using Propanoic acid as the organic acid (Across Chemical, division of Ranbaxy Laboratories, India).

In addition to Propanoic acid used herein, other organic acids could be utilized. Some suitable organic acids include: Formic acid, Acetic acid, Trichloroacetic acid, Dichloroacetic acid, Oxalic acid, Acetoacetic acid, Bromoacetic acid, Chloroacetic acid, Iodoacetic acid, Phenylacetic acid, Thioacetic acid, Glycolic acid, Cacodylic acid, Cyanoacetic acid, Acrylic acid, Pyruvic acid, Malonic acid, Propanoic acid, Chloropropanoic acid, Hydroxypropanoic acid, Lactic acid, Glyceric acid, Cysteic acid, Barbituric acid, Alloxanic acid, Maleic acid, Oxaloacetic acid, Methymalonic acid, Succinic acid, Malic acid, Tartaric acid, Dihydroxytartaric acid, Butanoic acid, Hydroxybutanoic acid, Chlorobutanoic acid, Aspartic acid, Itaconic acid, Mesaconic acid, Dimethylmalonic acid, Glutaric acid, Methylsuccinic acid, L-Glutamic acid, Diaminopimelic acid, Pentanoic acid, Trimethylacetic acid, Picric acid, Picolinic acid, Pyridinecarboxylic acid, Benzenesulfonic acid, Aminobenzenesulfonic acid, Ascorbic acid, Citric acid, Isocitric acid, Carboxyglutamic acid, Adipic acid, Adiparnic acid, Hexanoic acid, Bromobenzoic acid, Chlorobenzoic acid, Iodobenzoic acid, Dinicotinic acid, Dipicolinic acid, Lutidinic acid, Nitrobenzoic acid, Quinolinic acid, Benzoic acid, Hydroxybenzoic acid, Dihydroxybenzoic acid, Dihydroxymalic acid, Gallic acid, Aminobenzoic acid, Cyclohexanecarboxylic acid, Heptanedioic acid, Ethylglutamic acid, Heptanoic acid, Phthalic acid, Terephthalic acid, Chlorophenylacetic acid, Nitrophenylacetic acid, Toluic acid, Homogentisic acid, Octanoic acid, Chlorocinnamic acid, Cyanophenoxyacetic acid, Cinnamic acid, Hippuric acid, Mesitylenic acid, Nonanic acid, Methylcinnamic acid, Naphthoic acid, Tridecylamine, and Diphenylacetic acid.

Each of the metal containing compounds that were used to manufacture a specified catalyst using the sol-gel technique were placed in glass flasks with enough organic acid (between 400 and 1000 ml) to dissolve the salts. Each flask was equipped with reflux condensers. The solutions were heated with an electric mantle until boiling. The mixtures were boiled until the oxides and salts were dissolved (approximately 2-5 hours at a temperature between 90° C.-140° C.), thus forming individual organo-metallic solutions.

The solutions were then combined in a ratio to give the desired composition.

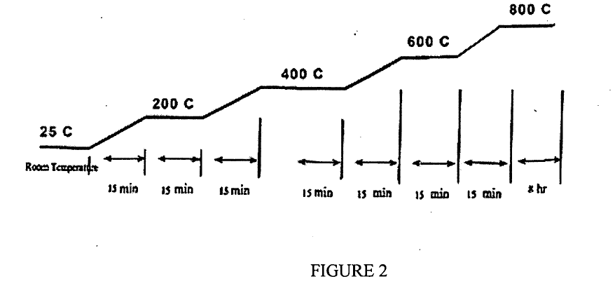

The resulting mixture was then heated without reflux to evaporate the excess liquid until a thick gel formed (approximately 2-3 hours). The gel was dried, crushed, and the powder placed in a ceramic tray in an electrically heated furnace where it was calcined to produce the catalyst according to the temperature profile outlined in FIG. 2.

As shown in FIG. 2 (not to scale), temperature ramp increases of approximately 200° C. occur over about ¼-½ hour (h) followed by a holding period of a similar ¼-½ hour until a target temperature in the range from about 700° C. to about 1000° C. is reached, preferably about 800° C. The powdered material is subjected to the final calcination temperature for an additional period of about 8 hours or more during which time calcination occurs. Accordingly, in one embodiment of the present invention, starting from a room temperature (ambient temperature) of about 25° C., 7 steps of ¼ hour each will result in a final calcination temperature of about 800° C. in about 1 and ¾ hours.

After calcining, the calcined material is pulverized and mixed in the desired ratio with the EPC component. The mix is dry blended to a uniform consistency and then pressed into pellets. The pellets are then crushed into a size suitable for the reactor being used. The particle sizes ranged from about one-tenth millimeter (0.1 mm) to about 5 millimeters (5 mm). In some experiments, particles having an average size ranging from about 0.15 mm to about 0.45 mm were used, and others used particles having an average size ranging from about 2 mm to about 4 mm.

2. Impregnation Technique Used to Produce Catalyst Components

Several catalyst components in Table 1 and 2 were prepared using what is referred to as an impregnation method. A salt form of the particular metal is dissolved in warm water (at a temperature ranging from between 60 degrees C. to 80 degrees C.). The support material (such as, for example only, Al₂O₃ or SiO₂, or other support agent) is added to the warm solution, and the resulting mixture stirred continuously while maintaining the temperature between 60 degrees C. to 80 degrees C., for a period of time that is sufficient for the consistency of the mixture to be the consistency of a thick paste. This time period ranges from between 1 hour to about 25 hours, depending upon the particular materials. The mixture is then dried in an oven until it is dry (generally for 1-2 hours at a temperature of about 250 degrees F. (121 degrees C.). The dried mixture is then calcined in a furnace at a temperature of about 800 degrees C. for a period ranging from about 4 to about 10 hours. After calcining, the mixture is ground, and sieved using a standard mesh sieve. The sieved composition is then pressed in a Carver Laboratory Press (Model 3912) at a pressure ranging from about 10,000 to about 14,000 pounds per square inch (68947 to 96526 kPa). After the composition has been pressed, it is again ground, sieved through a standard mesh sieve to the size appropriate for the reactor.

In the Sol-Sol technique water is combined with 1 to 2 grams of methyl 2-hydroxy ethyl cellulose (Tylose) or another suitable green strength binder. The metal compounds (as shown in Table 1 and 2), are then added. To this mix is added 10-15 grams of vinyl acetate-butyl acrylate copolymer. Other suitable organic binder includes methylcellulose, hydroxypropyl methylcellulose, polyvinyl alcohol, polyacrylate polymer, polyacrylamide polymer, guar gum, xanthans and alginates. The mixture is then dried and calcined at 800° C. for 8 hours.

A green strength binder is a compound or agent that will have strength sufficient to retain the admixture while in the uncured state, i.e., prior to the drying and calcination steps.

The calcined catalyst component is then pulverized and then dry blended with other catalyst components (either made with the sol-sol or sol-gel technique. The blend is pressed and then ground into a size suitable for the reactor being used. The particle sizes ranged from about one-tenth millimeter (0.1 mm) to about 5 millimeters (5 mm). In some experiments, particles having an average size ranging from about 0.15 mm to about 0.45 mm were used, and others used particles having an average size ranging from about 2 mm to about 4 mm.

3. Physical Blending of Catalyst Components

This technique is primarily applicable to the SmBaTiO₃/FeMoO₄ catalyst (catalyst #5 in Table 1), comprising a mixture of 70 weight % SmBaTiO₃ with 30 weight %. FeMoO₄. After the respective individual compositions were prepared, using, for example, the sol-gel technique for SmBaTiO₃, the resulting powders are sized through a standard mesh screen, and combined as specified, and the container mixed (at ambient temperature) for a time period sufficient to effect a thorough mixing of the components. Once the mixing has been completed, the resulting blend is pressed, then sized to the particle size appropriate for the reactor, as described for the previous techniques.

Notes Concerning Reagents:

The molybdenum source was ammonium heptamolybdate [(NH₄)₆Mo₇O₂₄.4H₂o], also referred to as ammonium molybdate tetrahydrate. Silicalite S-115 was from Union Carbide Co., and is reported to have a ratio of SiO₂ to Al₂O₃ of about 3000; LUDOX® HS40 was one source of SiO₂. Barium sources included BaO, BaCl₂ or Ba(NO₃)₂, although other salts could be utilized.

The following measurement techniques and definitions apply to the examples that follow:
1. Liquid flow rates were metered by use of syringe pumps and/or positive displacement pumps. In each case the pumps were calibrated for the particular flow settings.
2. Gas flow rates were measured with mass flow meters and reported as gas flow rates at 0° C. and 1 atmosphere (101.325 kPa).
3. Composition of the gas feed was calculated based on flow rates determined from the mass flow meters. The gas composition as measured by gas chromatography was also determined to be the same as the composition calculated from the mass flow meters.
4. The composition of the exit gases from the reactor was measured by gas chromatography using a gas chromatograph calibrated with standard gas mixtures. An internal standard of nitrogen was used to calculate the exit flow rate of the gas from the reactor.
5. Condensed water from the reactor was collected and measured gravimetrically. Calculated wet basis measurements were based on including the water reactant products in the total reactants.
Dry basis measurements were calculated by eliminating all water from the reactor outlet and then calculating mole ratios. The tables are in mole % or molar flow rates. Weight % or weight ratios are not presented in the examples.
6. Temperatures in the reactor were measured by use of a thermocouple that could be moved up and down within a thermowell inserted into the center of the reactor.
7. Space velocities were calculated as volumetric feed rate of the gas feed calculated at 0° C. and 1 atmosphere, divided by the volume of the catalyst. In some cases weight hourly space velocities (“WHSV”) are reported and these were based either on the total mass flow rate of the feed divided by the mass of catalyst or the mass flow rate of methane divided by the total mass of catalyst.
8. Conversion (“Conv”) of methane is calculated as the moles of methane fed minus the moles of methane in the reactor exit and this difference is divided by the methane fed. The percent conversion is 100 times the fractional conversion.
9. Conversion of oxygen is calculated as the moles of oxygen fed minus the moles of oxygen in the reactor exit and this difference is divided by the oxygen fed. The percent conversion is 100 times the fractional conversion.
10. Selectivity (“Sel”) is calculated by two methods: 1) Utilizing the total flow rate that is calculated using nitrogen as a tie component, i.e., forcing a nitrogen balance and the exit composition of the gas leaving the reactor. The ethylene produced times 2 divided by the methane consumed is equal to the ethylene selectivity. 2) The second method forces a carbon balance and calculates the selectivity from only the exit composition of the gas from the reactor. These two methods should give the same results unless there are measurement or analytical errors. The two methods gave an indication of the error in the measurements and the assumption that there is no coking of the reactor. In the case of hydrocarbon feeds having carbon numbers greater than that of propane, the differences in selectivities indicate accumulation of carbon, in the form of coke, inside the reactor.
11. Yield is the product of the conversion times the selectivity. Ultimate yield for a process with recycle is equal to the selectivity for the single pass reactor experiments.
   Yield=(Conv)(Select)

### Example 1

### Effects of a Mixed Catalyst on Methane Conversion

This example used an OCM/EPC catalyst prepared by combining catalyst component # 14 (SnBaTiO₃) from Table 1 with catalyst component # 15 (NaMo/SiO₂) as shown in Table 2.

Catalyst component #14 was prepared using the sol-sol method described in Example 1, and paragraphs 25 through 38 of U.S. Patent App. Pub. No. 2004/0220053 A1 (Bagherzadeh et al, incorporated by reference herein in its entirety). Briefly, an aqueous slurry containing the metal salts is prepared, a polymeric binder added to the slurry to form a paste, which is then dried, crushed to a size appropriate for the reactor into which the catalyst will be used, and then calcined. After calcining, the calcined material was pressed, crushed and sieved to a sized appropriate for the reactor.

Catalyst component #15 (NaMo/SiO₂) was prepared using the Sol-Sol method by mixing water and 1.36 gr methyl 2-hydroxy ethyl cellulose (Tylose from SE Tylose GmbH & Co. KG in Wiesbaden, Germany) with SiO₂ and Ammonium heptamolybdate in molar ratios of 1 mole Na to one mole Mo to one mole SiO₂. The mixture is dried and calcined at 800° C. for 8 hours.

Catalyst component # 14 was combined with catalyst component # 15 in a 90:10 wt % ratio. The combined catalyst was mechanically mixed to a uniform consistency and pressed to 7 tons into pellets. The pellets were then crushed to a size ranging from 2-4 mm. The reactor was loaded with 44 grams of this catalyst.

TABLE 3
Effects of a mixed catalyst on methane conversion.

| | | |
|---|---|---|
| Feed Gas | N2, ml/min | 142.29 |
| mol % | O2, ml/min | 140.98 |
| | CH4, ml/min | 282.40 |
| | CO2, ml/min | 563.66 |
| | Steam, g/hr | 0.00 |

Total Gas flow rate GHSV = 2710

Reactor Outlet Composition

| Components | mol % |
|---|---|
| H2 | 1.65 |
| O2 | 0.00 |
| N2 | 0.00 |
| CO | 8.03 |
| CH4 | 0.00 |
| CO2 | 16.27 |
| C2H4 | 12.01 |
| C2H6 | 1.44 |
| C3H8 | 0.06 |
| C3H6 | 0.35 |
| I—C4H10 | 0.05 |
| N—C4H10 | 0.00 |
| C4H8 | 0.15 |
| C5H12 | 0.25 |
| C5H10 | 0.00 |
| C6+nonarom | 0.03 |
| Benzene | 0.01 |
| toluene | 0.06 |
| xylene | 0.01 |
| aromC9+ | 0.00 |
| Water | 59.64 |
| C₂ Sel, % | 48.72 |
| C₂₊ Sel, % | 55.99 |
| C₂ Yield, % | 23.52 |
| C₂₊ Yield, % | 27.03 |
| Methane Conversion | 48.44% |
| Oxygen Conversion | 94.30% |

The results (Table 3) show a high level of methane conversion with a yield of organic compounds with carbon number greater than 2 (C₂+yield) of 27%.

### Example 2

### Effects of an Alternate Mixed Catalyst on Methane Conversion

This example used an OCM/EPC catalyst prepared by combining catalyst component # 14 (SnBaTiO₃) from Table 1 with catalyst component # 19 (KV on SiO₂, 5% K, 10% V, 85% SiO₂) as shown in Table 2.

Catalyst component # 14 was prepared as described in Example 1.

Catalyst component #19 (KV on SiO₂) was prepared using the Sol-Sol method by mixing water and 1.36 gr methyl 2-hydroxy ethyl cellulose (Tylose from SE Tylose GmbH & Co. KG in Wiesbaden, Germany) and the potassium and vanadium components. To this mix is added 13.9 gm of vinyl acetate-butyl acrylate copolymer as an organic binder. The weight % of the components was 5 wt % potassium, 10 wt % vanadium and 85 wt % SiO₂. The mixture is dried and calcined at 800° C. for 8 hours.

Catalyst component # 14 was combined with catalyst component # 19 in a 90:10 wt % ratio. The combined catalyst was mechanically mixed to a uniform consistency and pressed to 7 tons into pellets. The pellets were then crushed to a size ranging from 2-4 mm. The reactor was loaded with 43 grams of this catalyst.

TABLE 4

| | | |
|---|---|---|
| Feed Gas | N2, ml/min | 148.54 |
| mol % | O2, ml/min | 140.98 |
| | CH4, ml/min | 281.92 |
| | CO2, ml/min | 565.56 |
| | Steam, g/hr | 0.00 |

Total flow rate GHSV = 2729

Reactor Outlet

| Components | mol % |
|---|---|
| H2 | 2.77 |
| O2 | 0.00 |
| N2 | 0.00 |
| CO | 13.06 |
| CH4 | 0.00 |
| CO2 | 4.92 |
| C2H4 | 13.13 |
| C2H6 | 1.35 |
| C3H8 | 0.05 |
| C3H6 | 0.29 |
| I—C4H10 | 0.05 |
| N—C4H10 | 0.00 |
| C4H8 | 0.11 |
| C5H12 | 0.17 |
| C5H10 | 0.00 |
| C6+nonarom | 0.01 |
| Benzene | 0.01 |
| toluene | 0.04 |
| xylene | 0.01 |
| aromC9+ | 0.00 |
| Water | 64.03 |
| C₂ Sel, % | 57.99 |
| C₂₊ Sel, % | 63.99 |
| C₂ Yield, % | 24.42 |
| C₂₊ Yield, % | 26.95 |
| Methane Conversion | 44.13% |
| Oxy Conversion | 77.88% |

The results (Table 4) show a high level of methane conversion with a yield of organic compounds with carbon number greater than 2 (C₂+yield) of approximately 27%.

### Example 3

### Effects of a Catalyst Prepared Only by the Sol-Gel Method on Methane Conversion

This example used an OCM catalyst which was only made by the sol-gel technique. The catalyst composition is that shown in Table 1 as #1 (SmBaTiO₃). The catalyst was prepared using oxides of samarium (Sm) and barium (Ba) in the forms of SmO₃ and BaO, respectively, and TiCl₄ (all sourced from Sigma-Aldrich, St. Louis, Mo.), mixed in separate containers, each with 400 cc propionic acid and refluxed for 5 hours at 130 degrees C. The ratio of metal components was calculated based on the resulting perovskite crystal (SmBaTiO₃) containing titanium in the form of an octahedron and having equal molar ratios as indicated in Table 1. The individual solubilized metal organic components were combined and then the solvent evaporated to form a gel. The gel was dried and calcined at 800 degrees C. for 8 hours.

Since this catalyst is an oxidation catalyst, there are endothermic reactions occurring when exposed to methane and oxygen. In this example the reactor dimensions were 25 mm (outer diameter, “O.D.”, 21 mm inner diameter “I.D.”) and the amount of catalyst used was 20 cc, having a weight of 39.726 grams.

The reactor was heated with three independent furnaces at top, middle and bottom sections. The reactor was heated up to 450 degrees C. with nitrogen flow at about 100 ml/min. At 450 degrees C. and above, the reactor was heated up with the reactant mixture: Nitrogen: 150 ml/min (gas flow rates are given at 0 degrees C. and 1 atm ((101.325 kPa))

Oxygen: 201 mm/min

Methane: 407 m/min

Water: 76.5 g/hr=1587 m/min (vapor, calculated at 0 degrees C. and 1 atm((101.325 kPa))

The reactant mixture in mole is N₂:O₂:CH₄:H₂O=1.5:2:4:15.9 (6.40, 8.57, 17.36, and 67.67 mol %)

Water was injected in an attempt to control catalyst bed temperatures. However, when the reactor was heated to about 650 degrees C., the reactor bed temperature increased to about 880 degrees C. in about 10 minutes. Then CH₄ was shut off and the reactor bed temperature was cooled down. Temperature control was not possible due to the exothermic nature of this catalyst and the amount of catalyst present.

The same experiment was conducted and the temperatures controlled to just below the point where they became uncontrolled in the previous run. The results of this data are shown in Table 5.

TABLE 5
Effects of a catalyst prepared only by the
sol-gel method on methane conversion.

| | | |
|---|---|---|
| Feed Gas | N2, ml/min | 150 |
| mol % | O2, ml/min | 200.9 |
| | CH4, ml/min | 406.9 |
| | Steam, g/hr | 76.5 |

Total GHSV 7037

Reactor Outlet

| Components | mol % |
|---|---|
| H2 | 0.00 |
| O2 | 5.67 |
| N2 | 0.00 |
| CO | 19.74 |
| CH4 | 11.38 |
| CO2 | 0.00 |
| C2H4 | 5.67 |
| C2H6 | 2.22 |
| C3H8 | 0.08 |
| C3H6 | 0.60 |
| I—C4H10 | 0.30 |
| N—C4H10 | 0.07 |
| C4H8 | 0.75 |
| C5H12 | 0.08 |
| C5H10 | 0.00 |
| C6+nonarom | 0.03 |
| Benzene | 0.16 |
| toluene | 0.00 |
| xylene | 0.00 |
| aromC9+ | 0.00 |
| Water | 56.39 |
| C2 Sel, % | 44.85 |
| C2 Yield, % | 17.75 |
| Methane Conversion | 39.58% |
| Oxy Conversion | 93.61% |

The results (Table 5) show that using an OCM catalyst alone yields a 17% conversion to organics with carbon number greater than 2. This conversion is much lower than the catalyst of Example 1 that utilizes OCM/EPC compositions.

### Example 4

### Effects of chloride ions on an OCM catalyst

This example used an OCM catalyst only. The catalyst composition is that shown in Table 1 as #1 (SmBaTiO₃).

Carbon tetrachloride (CCl₄) is injected into the reactor feed stream at the rate of 0.2 microliters every two hours to maintain catalyst activity.

TABLE 6
Effects of chloride ions on an OCM catalyst.

| | | |
|---|---|---|
| Feed Gas to reactor | N2, ml/min | 223 |
| mol % | O2, ml/min | 55.8 |
| | CH4, ml/min | 113 |
| | Steam, g/hr | 0 |

Total gas flow GHSV-1175

| Components | mol % |
|---|---|
| H2 | 2.34 |
| O2 | 0.00 |
| N2 | 0.00 |
| CO | 8.03 |
| CH4 | 0.00 |
| CO2 | 34.04 |
| C2H4 | 18.93 |
| C2H6 | 2.65 |
| C3H8 | 0.00 |
| C3H6 | 0.97 |
| I—C4H10 | 0.08 |
| N—C4H10 | 0.00 |
| C4H8 | 0.90 |
| C5H12 | 0.00 |
| C5H10 | 0.00 |
| C6+nonarom | 0.00 |
| Benzene | 0.21 |
| toluene | 0.00 |
| xylene | 0.00 |
| aromC9+ | 0.00 |
| Water | 31.85 |
| Methane Conversion | 45.24 |
| Oxy Conversion | 100.00 |
| Selectivity to C2H4 | 42.06 |
| Selectivity to CO + CO2 | 46.73 |
| Selectivity to ethane | 5.89 |
| C2H4 yield, % | 19.03 |

The results (Table 6) show that OCM catalyst alone yields 15 to 25% less C₂+ compounds than the catalyst prepared using the combined components of an OCM/EPC catalyst, even in the presence of chloride ions.

### Example 5

### Effects of a 70:30 Blend of OCM:EPC Catalyst on Methane Conversion

This example shows the effect of a catalyst made with a 70 weight % blend of catalyst ingredient #14 (OCM component) and 30 weight % catalyst ingredient #15 (EPC component) from Table 1 and 2.

TABLE 7
Effects of a 70:30 blend of OCM:EPC catalyst on methane conversion.

| | | |
|---|---|---|
| Reactor inlet Feed gas | N2, ml/min | 192.30 |
| mol % | O2, ml/min | 239.99 |
| | CH4, ml/min | 369.11 |
| | CO2, ml/min | 739.40 |
| | Steam, g/hr | 0.00 |

Catalyst volume, 33 cc weight, 49.4 grams Total GHSV 2801

| Components | mol % |
|---|---|
| H2 | 0.78 |
| O2 | 0.00 |
| N2 | 0.00 |
| CO | 12.14 |
| CH4 | 0.00 |
| CO2 | 9.90 |
| C2H4 | 0.78 |
| C2H6 | 1.05 |
| C3H8 | 0.06 |
| C3H6 | 0.26 |
| I—C4H10 | 0.00 |
| N—C4H10 | 0.00 |
| C4H8 | 0.13 |
| C5H12 | 0.24 |
| C5H10 | 0.00 |
| C6+nonarom | 0.03 |
| Benzene | 0.01 |
| toluene | 0.06 |
| xylene | 0.01 |
| aromC9+ | 0.00 |
| Water | 61.78 |
| Methane Conversion % | 53.71 |
| Oxy Conversion % | 92.20 |
| Selectivity to C2H4 % | 48.32 |
| Sel to CO % | 21.63 |
| Sel to CO + CO2 % | 39.28 |
| Sel to ethane % | 3.75 |
| C2H4 yield, % | 25.95 |
| C₂ Yield, % | 27.72 |
| C₂₊ Yield, % | 30.93 |

The results (Table 7) indicate another example of the synergy between OCM and EPC catalyst components. In this case the OCM component uses a tin component and the results show a nearly 31% conversion to C₂+product.

### Example 6

### Effects of a Molybdenum Containing Catalyst on Methane Conversion

This example utilizes the components of catalyst 14 and catalyst 18 (see Tables 1 and 2) in a 90:10 weight % basis. The results (Table 8) show the effect of a molybdenum containing catalyst composition used for the EPC component. The molybdenum catalyst component in this example was prepared using the impregnation technique.

TABLE 8
Effects of a molybdenum containing catalyst on methane conversion.
Reactor Inlet

| | | |
|---|---|---|
| Feed Gas | N2, ml/min | 145.54 |
| mol % | O2, ml/min | 140.98 |
| | CH4, ml/min | 281.92 |
| | CO2, ml/min | 565.56 |
| | Steam, g/hr | 0.00 |

Catalyst-, volume, CC-25
Total GHSV 2722

Reactor Outlet

| Components | mol % |
|---|---|
| H2 | 2.85 |
| O2 | 0.00 |
| N2 | 0.00 |
| CO | 11.61 |
| CH4 | 0.00 |
| CO2 | 3.90 |
| C2H4 | 13.53 |
| C2H6 | 2.11 |
| C3H8 | 0.05 |
| C3H6 | 0.38 |
| I—C4H10 | 0.05 |
| N—C4H10 | 0.00 |
| C4H8 | 0.14 |
| C5H12 | 0.19 |
| C5H10 | 0.00 |
| C6+nonarom | 0.00 |
| Benzene | 0.01 |
| toluene | 0.05 |
| xylene | 0.02 |
| aromC9+ | 0.00 |
| Water | 65.09 |
| Methane Conversion % | 37.94 |
| Oxy Conversion % | 67.10 |
| C₂ Sel, % | 62.12 |
| C₂₊ Sel, % | 69.20 |
| C₂ Yield, % | 22.20 |
| C₂₊ Yield, % | 24.74 |

### Example 7

### Effects of Chloride Ion on Catalyst Containing Barium and Molybdenum Composition

Catalyst component #14 (OCM component) with catalyst component #25 (EPC component). The EPC component comprises barium and molybdenum metals.

TABLE 9
Effects of chloride ion on catalyst containing barium and molybdenum
composition.

| | | | |
|---|---|---|---|
| Feed | N2, ml/min | 157.00 | 0.1377 |
| Gas | O2, ml/min | 140.60 | 0.1233 |
| mol % | CH4, ml/min | 281.30 | 0.2467 |
| | CO2, ml/min | 561.47 | 0.4924 |
| | Steam, g/hr | 0.00 | 0.0000 |

Catalyst volume, CC 25
weight, 45.2200 g
Total GHSV 2737

Reactor Outlet

| Components | rate, mol/hr | mol % |
|---|---|---|
| H2 | 0.0165 | 0.53 |
| O2 | 0.0842 | 2.72 |
| N2 | 0.4203 | 13.59 |
| CO | 0.0680 | 2.20 |
| CH4 | 0.4625 | 14.96 |
| CO2 | 1.5136 | 48.96 |
| C2H4 | 0.0829 | 2.68 |
| C2H6 | 0.0108 | 0.35 |
| C3H8 | 0.0003 | 0.01 |
| C3H6 | 0.0017 | 0.06 |
| I—C4H10 | 0.0002 | 0.01 |
| N—C4H10 | 0.0000 | 0.00 |
| C4H8 | 0.0007 | 0.02 |
| C5H12 | 0.0011 | 0.04 |
| C5H10 | 0.0000 | 0.00 |
| C6+nonarom | 0.0001 | 0.00 |
| Benzene | 0.0000 | 0.00 |
| toluene | 0.0002 | 0.01 |
| xylene | 0.0000 | 0.00 |
| aromC9+ | 0.0000 | 0.00 |
| Water | 0.4284 | 13.86 |
| Methane Conversion | 38.58% | |
| Oxy Conversion | 77.62% | |

CCl₄ is fed continuously at 160 ul/hr (0.054 v %,
final concentration), starting when the temperature in the
reactor bed is about 520 degrees C to 540 degrees C.

### Example 8

### Effects of Catalyst Particle Size on Methane Conversion

This Example utilized a mix of catalyst component # 14 (70 wt %) with catalyst component #15 (30 wt %). The catalyst was crushed to a sized ranging from 0.45 to 0.17 mm. The results (Table 10) indicate that the particle size of the catalyst can affect the yield and conversions of methane to C₂+ compounds. As shown in Table 10, for the size reactor employed, smaller catalyst particles produce a greater yield.

TABLE 10
Effects of catalyst particle size on methane conversion..

| | | | |
|---|---|---|---|
| Feed Gas | N2, ml/min | 146.55 | 0.1291 |
| mol % | O2, ml/min | 140.98 | 0.1242 |
| | CH4, ml/min | 281.92 | 0.2484 |
| | CO2, ml/min | 565.56 | 0.4983 |
| | Steam, g/hr | 0.00 | 0.0000 |

Catalyst volume, CC-34; weight, 51.4000 g
Total GHSV 2003

Reactor Outlet

| | rate, | |
|---|---|---|
| Components | mol/hr | mol % |
| H2 | 0.0070 | 0.23 |
| O2 | 0.0057 | 0.18 |
| N2 | 0.3923 | 12.75 |
| CO | 0.0805 | 2.62 |
| CH4 | 0.3690 | 12.00 |
| CO2 | 1.5715 | 51.09 |
| C2H4 | 0.0975 | 3.17 |
| C2H6 | 0.0084 | 0.27 |
| C3H8 | 0.0005 | 0.01 |
| C3H6 | 0.0022 | 0.07 |
| I—C4H10 | 0.0000 | 0.00 |
| N—C4H10 | 0.0000 | 0.00 |
| C4H8 | 0.0009 | 0.03 |
| C5H12 | 0.0019 | 0.06 |
| C5H10 | 0.0000 | 0.00 |
| C6+nonarom | 0.0002 | 0.01 |
| Benzene | 0.0001 | 0.00 |
| toluene | 0.0004 | 0.01 |
| xylene | 0.0001 | 0.00 |
| aromC9+ | 0.0000 | 0.00 |
| Water | 0.5379 | 17.49 |

CCl4 is fed continuously at 160/214/160 ul/hr (0.054 v %,
final concentration) starting when the temperature
in the reactor bed is about 520 degrees C. to 580 degrees C.

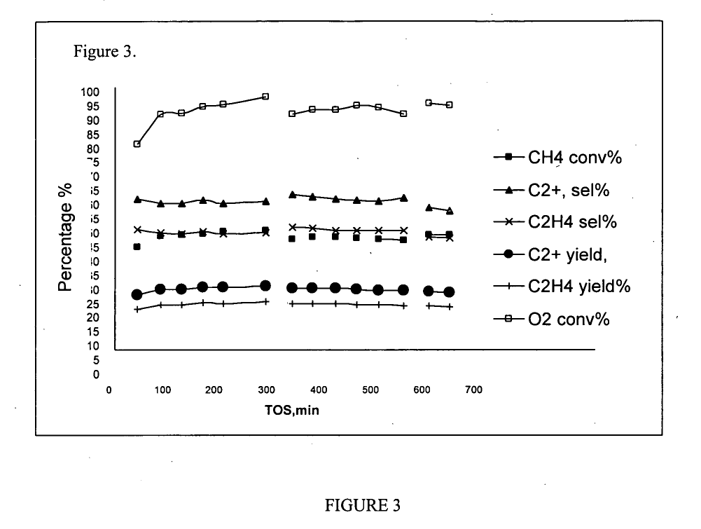

To illustrate the longevity of the catalyst the run was extended over several hours and the results shown in FIG. 3.

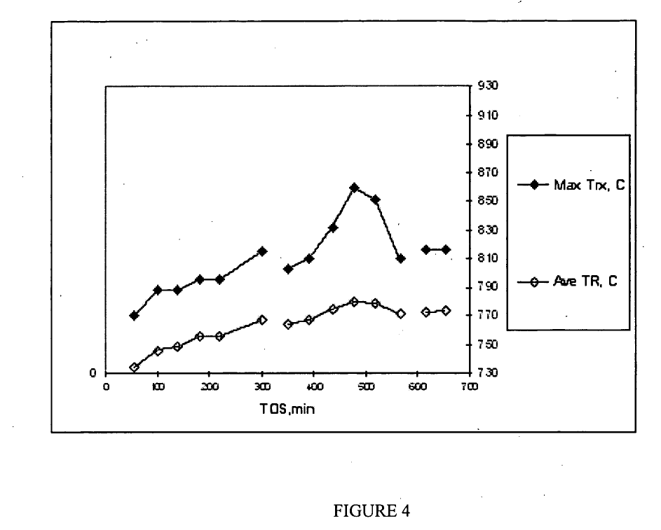

Temperature control was ramped up over time to find optimal conversion temperatures. The data in FIG. 4 shows that the process utilizing the catalyst of the present invention demonstrates the ability to control temperatures within the reaction zone.

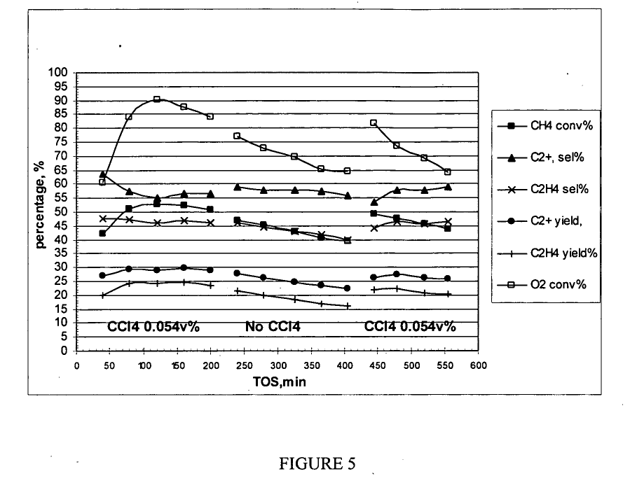

To illustrate the effect of chloride addition on catalyst life and activity the carbon tetrachloride (CCl₄) feed was eliminated during the run (see FIG. 5). It can be seen that when the CCl₄ is turned off, the yield of C₂+ conversion products declines. Re-addition of the CCl₄ reactivates the catalyst but not to the extent of the original activity.

### Example 9

### Effects of Oxygen Injection on Methane Conversion

This example used similar catalyst and conditions to Example 8 but oxygen was injected at multiple points along the catalyst bed in order to test the effect of distributed O₂ injection. Oxygen (O₂) injection points were placed in the flow direction:

The first opening for oxygen injection was in the catalyst bed at a distance of 83 mm from where the catalyst is positioned above the first layer of quartz in the reactor, and the additional openings were positioned at a distance of 50 mm from the previous opening. The first opening has a diameter of 0.013″ (0.33 mm), the second opening a diameter of 0.015″ (0.38 mm), the third opening a diameter of 0.031″ (0.79 mm) and the end opening a diameter of 0.038″ (0.97 mm).

TABLE 11
Effects of oxygen injection on methane conversion.

| | | | |
|---|---|---|---|
| Reactor | N2, ml/min | 194.11 | 0.1271 |
| Feed Gas | O2, ml/min | 190.48 | 0.1247 |
| mol % | CH4, ml/min | 380.73 | 0.2493 |
| | CO2, ml/min | 761.90 | 0.4989 |

Catalyst volume, CC 30
weight, g 43.9500
Total GHSV 3054

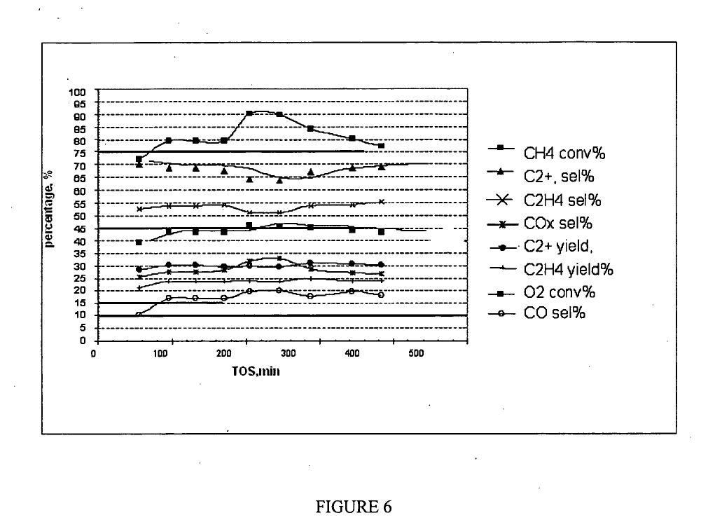

FIG. 6 illustrates the effect of multiple oxygen injection points. It can be seen that C₂+ conversions exceed 30% with much higher methane conversions with this technique.

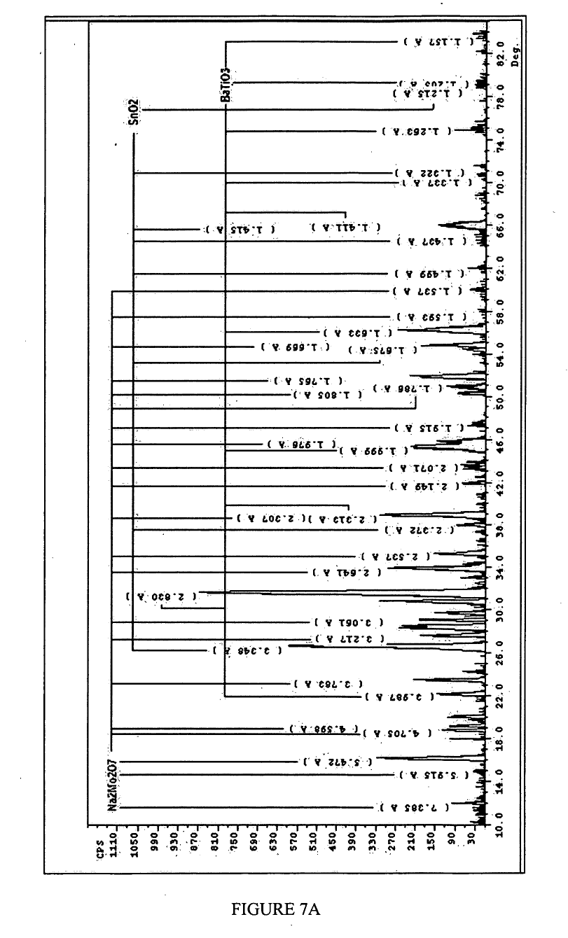

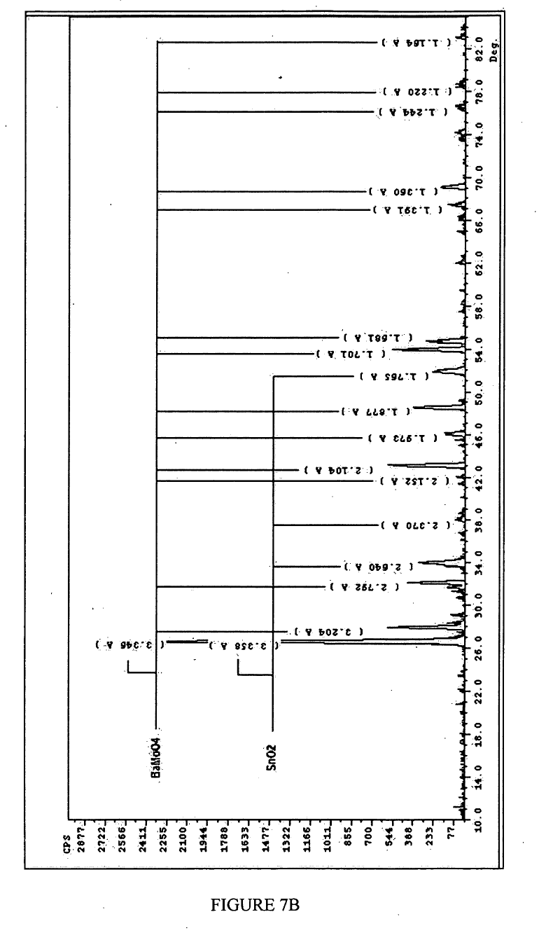

As noted previously the catalyst utilized in the present invention combines two catalyst components made in separate processes and then pressed and placed in the reactor. In the reactor there is a conditioning of the combined catalyst by means of heat history into a new catalyst compound. FIG. 7 shows X-Ray Diffraction scans of the catalyst used in this experiment prior to and after having been used in the reactor. It can be seen that the mixed metal catalyst has transformed into a new catalyst after having been exposed to the reactor conditions. The new catalyst could be made by exposing the mixed metal catalyst to similar heat history external to the reactor and then transformed to the reactor for use.

### Example 10

### Effects of Using an EPC Catalyst Only on the Conversion of Methane

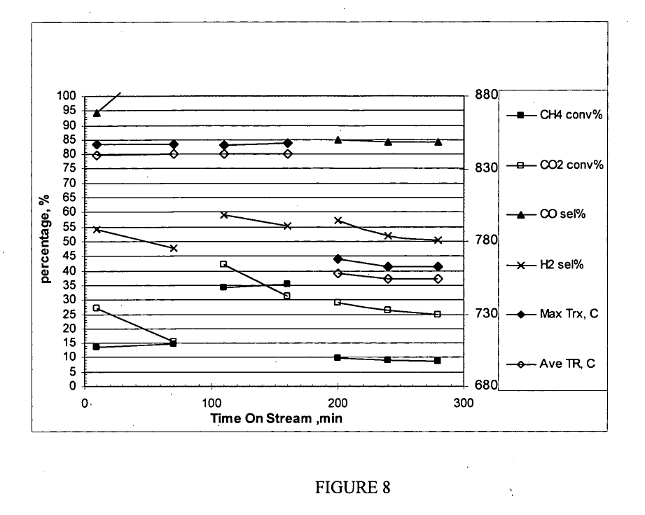

The EPC catalyst was tested alone to check its effectiveness in promoting endothermic reactions. Catalyst No. 15 (see Table 2) was evaluated in the absence of oxygen, with only methane and CO₂ present. The quantity of Catalyst No. 15 used was 10 cc (14 g), and the space velocity; GHSV=3200. The reactor was quartz lined. The results of this evaluation are shown in FIG. 8.

The results show that in the presence of Catalyst No. 15, and under the conditions indicated, both CO₂ and methane undergo exothermic reactions resulting in carbon monoxide and hydrogen production.

### Example 11

### Effects of Using an OCM/EPC Catalysts with and without Carbon Dioxide

To demonstrate that the OCM/EPC catalyst is reducing CO₂, the reactions were conducted with and without a CO₂ feed. The reactor is a titanium reactor, having an inner diameter (“ID”) of 12.6 mm, with a 6 mm outer diameter (“OD”) quartz thermowell. The catalyst was a 70:30 wt % mix of catalyst components # 14 and # 15, respectively, with a charge of 10 cc (14.5 g) of the catalyst. The inlet gas feed for the sets of data marked A and B are shown in Table 12. The results indicate higher conversions with the presence of CO₂ and the consumption of CO₂ in endothermic reducing/reforming reactions,

TABLE 12

| | A | B |
|---|---|---|
| Inlet Gas mix | 2:1:1:4 | 2:1:1:0 |
| CH4:O2:N2:CO2 | | |
| C2+ yield % | 26 | 22 |

What is claimed is:

1. A composition to oxidatively reform hydrocarbons, the composition comprising:
a first component having a composition represented by the formula ABTiO₃, wherein A is samarium (Sm) or tin (Sn), and B is barium (Ba); and
a second component having a composition represented by the formula XYZ, wherein:
X is a metal selected from Group IA, Group IIA or Group VIIIA of the Periodic Table of the Elements; or X is not present;
Y is a metal selected from Group VA, Group VIA, Group VIIA or Group VIIIA of the Periodic Table of the Elements; and
Z is chosen from the group consisting of oxygen, silica, silicalite or alumina.

2. The composition as described in claim 1, wherein in the second component,
X is a metal selected from Group IA or Group IIA of the Periodic Table of the Elements;
Y s a metal selected from Group VA or Group VIA of the Periodic Table of the Elements; and
Z is either oxygen or silica.

3. The composition as described in claim 2, wherein the Group IA metal is sodium (Na) or potassium (K).

4. The composition as described in claim 2, wherein Y is molybdenum (Mo), tungsten (W), or vanadium (V).

5. The composition as described in claim 4, wherein the second component comprises a composition selected from the group consisting of NaMoO₂, BaMoO₄, or KV on SiO₂ (5 weight % ((wt %)) K, 10 wt % V).

6. The composition as described in claim 2, wherein the first component comprises from about 50 weight % (wt %) to about 95 wt % of the composition, and the second component comprises from about 5 wt % to about 50 wt % of the composition.

7. The composition as described in claim 1, wherein the first component comprises equimolar quantities of A, Ba and TiO₃.

8. The composition as described in claim 6, wherein the composition is sized to a particle size ranging from about 0.1 millimeters (mm) to about 5 mm.

9. The composition as described in claim 8, wherein the composition is sized to a particle size ranging from about 2 millimeters (mm) to about 4 mm.

10. The composition as described in claim 8, wherein the composition is sized to a particle size ranging from about 0.15 millimeters (mm) to about 0.5 mm.

11. A method for the oxidative reforming of hydrocarbons, the method comprising the steps of:
producing a catalyst composition, the composition comprising:
a first component having a composition represented by the formula ABTiO₃, wherein A is samarium (Sm) or tin (Sn), and B is barium (Ba); and
a second component having a composition represented by the formula XYZ, wherein:
X is a metal selected from Group IA, Group IIA or Group VIIIA of the Periodic Table of the Elements; or X is not present;
Y s a metal selected from Group VA, Group VIA, Group VIIA or Group VIIIA of the Periodic Table of the Elements; and
Z is chosen from the group consisting of oxygen, silica, silicalite or alumina;
sizing the catalyst composition to a size suitable for use in an oxidative reforming reactor;
adding a quantity of the sized catalyst composition to the oxidative reforming reactor; and
contacting a feed gas stream containing a hydrocarbon and oxygen in the oxidative reforming reactor under oxidative reforming conditions in the presence of the catalyst composition.

12. The method as described in claim 11, wherein the feed gas hydrocarbon comprises one or more compounds chosen from the group consisting of methane, ethane, propane, butane, hexane, heptane, normal-octane, iso-octane, naphtha, liquefied petroleum gas and middle distillate hydrocarbons.

13. The method as described in claim 12, further comprising adding a halogen to the feed gas stream.

14. The method as described in claim 13, wherein the halogen is chloride.

15. The method as described in claim 14, wherein the chloride in the gas stream is selected from the group consisting of methane chloride, ethane chloride, ethylene dichloride, chlorine gas, chloroform, stannous chloride (SnCl₂), hydrochloric acid (HCl), or carbon tetrachloride (CCl₄).

16. The method as described in claim 13, wherein the halogen is added to a final concentration ranging from about 0.001% (volume/volume) to about 0.04% (volume/volume).

17. The method as described in claim 16, wherein the halogen is added to a final concentration ranging from about 0.008% (volume/volume) to about 0.02% (volume/volume).

18. The method as described in claim 12, wherein an end product of the oxidative reforming is carbon dioxide, and the method further comprises the step of recirculating the carbon dioxide into the feed gas.

19. The method as described in claim 11, wherein the sized catalyst composition has a particle size ranging from about 0.1 millimeters (mm) to about 5 mm.

20. The method as described in claim 11, wherein the second component comprises a composition selected from the group consisting of NaMoO₂, BaMoO₄, or KV on SiO₂ (5 weight % ((wt %)) K, 10 wt % V).

21. The method as described in claim 21, wherein the first component comprises from about 50 weight % (wt %) to about 95 wt % of the composition, and the second component comprises from about 5 wt % to about 50 wt % of the composition.

22. A composition to oxidatively reform hydrocarbons, the composition comprising:
a first component having a composition represented by the formula ABTiO₃, wherein A is samarium (Sm) or tin (Sn), and B is barium (Ba); and
a second component having a composition represented by the formula XYZ, wherein:
X is a metal selected from Group IA, Group IIA or Group VIIIA of the Periodic Table of the Elements; or X is not present;
Y is a metal selected from Group VA, Group VIA, Group VIIA or Group VIIIA of the Periodic Table of the Elements; and
Z is chosen from the group consisting of oxygen, silica, silicalite or alumina; and the first component is produced by a process comprising the steps of:
forming an aqueous slurry comprising an alkaline earth metal salt, a powdered
metal salt and a powdered transition metal oxide; and
adding a polymeric binder to the slurry to form a paste;
drying the paste to form a powder;
heating the powder at increasing temperatures at a predetermined profile commensurate with the polymeric binder;
calcining the heated powder to form the composition, and
sizing the composition to a size suitable for a catalytic reactor, wherein the powder is heated by raising the temperature of the powder in a temperature profile comprising a series of successive ramping and holding stages up to the calcining temperature, and wherein the temperature is raised to the calcining temperature at an increasing rate ranging from about 200° C. to about 400° C. per hour.

23. The composition as described in claim 22, wherein the slurry comprises an equimolar mixture including ABaTiO₃, wherein A is chosen from the group consisting of samarium (Sm) or tin (Sn).

24. The composition as described in claim 22, wherein the second component is produced by a process comprising the steps of:
preparing a solution of the metal in warm water (temperature ranging from about 60 degrees C. to about 80 degrees C.);
adding a support agent to the warm solution to form an admixture;
mixing the admixture for a time sufficient for the admixture to have the consistency of a thick paste;
drying the paste until the admixture is dry;
calcining the dried admixture at a temperature of about 800 degrees C. for a period ranging from about 4 hours to about 10 hours;
sizing the ground admixture to a particle size suitable for use in an oxidative reforming reactor;
pressing the sized admixture in a press; and
repeating the sizing step.

25. The composition as described in claim 24, wherein the first component and the second component are dry blended together.

26. A composition to oxidatively reform hydrocarbons, the composition comprising:
a first component being a perovskite catalyst having a composition represented by the formula ABTiO₃, wherein A is samarium (Sm) or tin (Sn), and B is barium (Ba); and
a second component being a composition represented by the formula XYZ, wherein
X is a metal selected from Group IA, Group IIA or Group VIIIA of the Periodic Table of the Elements; or X is not present;
Y s a metal selected from Group VA, Group VIA, Group VIIA or Group VIIIA of the Periodic Table of the Elements; and
Z is chosen from the group consisting of oxygen, silicate, silicalite or alumina.

27. The composition as described in claim 26, wherein in the second component, X is sodium (Na) or potassium (K).

28. The composition as described in claim 27, wherein Y is Y is molybdenum (Mo), tungsten (W), or vanadium (V).

29. The composition as described in claim 28, wherein Z is oxygen or silica.

30. The composition as described in claim 28, wherein the composition comprises from about 50 wt % to about 95 wt % SnBaTiO₃ and from about 5 wt % to about 50 wt % of the second component.
